(19) United States
(12) Patent Application Publication
(10) Pub. No.: US 2014/0115393 A1
(43) Pub. Date: Apr. 24, 2014

(54) Electronic Device And Connection Test Method

(71) Applicant: Kabushiki Kaisha Toshiba, Tokyo (JP)

(72) Inventors: Kazuki Kuwahara, Saitama-shi (JP); Masami Tanaka, Ome-shi (JP)

(73) Assignee: Kabushiki Kaisha Toshiba, Tokyo (JP)

(21) Appl. No.: 14/024,529

(22) Filed: Sep. 11, 2013

(30) Foreign Application Priority Data
Oct. 23, 2012 (JP) 2012-234155

(51) Int. Cl. G06F 11/273

(52) U.S. Cl. CPC G06F 11/273
USPC 714/27

(57) ABSTRACT

According to one embodiment, an electronic device includes a test module, a specification module, and a display. The test module is configured to test setting states of items necessary for Internet connection. The specification module is configured to specify a cause of being unable to establish connection to the Internet based on an item regarding which it has been determined by the test module that setting is not correctly carried out. The display is configured to display the cause specified by the specification module.

### CROSS-REFERENCE TO RELATED APPLICATIONS

This application is based upon and claims the benefit of priority from Japanese Patent Application No. 2012-234155, filed Oct. 23, 2012, the entire contents of which are incorporated herein by reference.

### FIELD

Embodiments described herein relate generally to an electronic device connectable to the Internet, and a connection test method thereof.

### BACKGROUND

At present, many electronic devices are not used as stand-alone devices. It has become necessary for the electronic devices to be used in a state where they are connected to the Internet. Connection of an electronic device to the Internet requires predetermined setting work. When the setting work is not correctly completed, or when, after the setting work is correctly completed, some trouble precluding the connection occurs, the function of the electronic device cannot be completely utilized.

In order to avoid such a state, a communication terminal device which makes it possible to carry out connection to the Internet by only carrying out a connection operation without carrying out any setting is proposed.

A test method in which when a request for a connection test is received from a connection information setting screen, a connection test is carried out, and a result and cause are displayed as the test result is also proposed.

Regarding a TV receiver provided with a web browser, connected to the Internet through a LAN cable, and capable of viewing web contents, it is also proposed to carry out connection confirmation of the LAN cable.

Further, an electronic device in which restoration information that has been used for connection to a network in a connection environment is stored for each of connection environments having actual results of network connection, a correction is made to connection information set to a connection processor by using the restoration information, whereby it is made possible to restore most faults is also proposed.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary block diagram of a television receiver for showing an example of the configuration of an embodiment.

FIG. 2 is an exemplary flowchart showing an example of a connection test method according to the embodiment.

FIG. 3 is an exemplary view showing an example of a confirmation screen of connection test execution.

FIG. 4 is an exemplary flowchart showing details of a connection test of a case where the connection type is wired.

FIG. 5 is an exemplary flowchart showing details of a connection test of a case where the connection type is wireless.

FIG. 6 is an exemplary view showing an example of a display screen of a connection test result (NG).

FIG. 7 is an exemplary view showing an example of a network setting menu screen.

FIG. 8 is an exemplary view showing an example of a screen of IP address setting which is an item of the network setting menu.

FIG. 9 is an exemplary view showing an example of a display screen of a connection test result (OK).

### DETAILED DESCRIPTION

Various embodiments will be described hereinafter with reference to the accompanying drawings.

In general, according to one embodiment, an electronic device includes a test module, a specification module, and a display. The test module is configured to test setting states of items necessary for Internet connection. The specification module is configured to specify a cause of being unable to establish connection to the Internet based on an item regarding which it has been determined by the test means that setting is not correctly carried out. The display is configured to display the cause specified by the specification module.

Hereinafter, an embodiment will be described with reference to the drawings. Although the embodiment is practicable for all electronic devices to be connected to the Internet, here a television receiver will be described.

The television receiver of the embodiment has a function of being connected to a server through the Internet, and being able to utilize a cloud service provided by the server. The television receiver records a large amount of television programs on a hard disk drive. The television receiver incorporates therein a number of tuners, records all the programs of a number of channels for a predetermined period, and reproduces the programs, whereby it is made possible to watch the television programs by time-shifting. It is almost impossible to select a program to be watched from the large amount of recorded programs. Thus, a cloud service of retrieving a program suiting the taste of the user, and recommending the program to be reproduced to the user is proposed. The server learns the tastes of the user by acquiring a viewing/reproduction history or the like of the user indicating the programs viewed/reproduced by the user. Alternatively, when the user inputs a keyword of a program which the user desires to reproduce, a program to be reproduced may be retrieved on the basis of the keyword. In this way, the cloud service notifies a reproduction-recommended program to each user.

In order to enjoy this service, it is necessary to connect the television receiver to the Internet. However, among television users, there are users who do not know that a particular setting should be carried out in order to connect a television receiver to the Internet. Further, even after setting is carried out, connection to the Internet cannot be established in some cases because of faults such as detached LAN cables, switched off routers, and the like. In this embodiment, when connection to the Internet cannot be established in a state where Internet connection is required, it is possible to notify the user of how to establish connection.

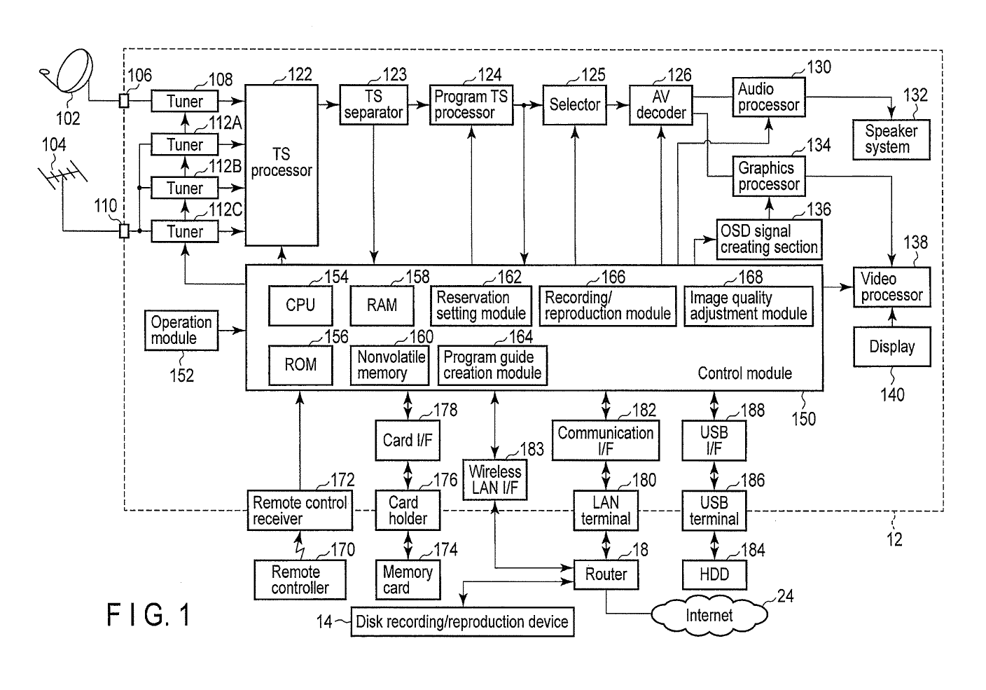

FIG. 1 is a block diagram of a television receiver provided with a function requiring Internet connection. The television receiver 12 is provided with a network function, and is connected to the Internet 24 through a router 18. Although FIG. 1 shows a state where the television receiver 12 is connected to the router 18 by a wire through a LAN terminal 180, it is also possible to connect the television receiver 12 to the router 18 by wireless through a wireless LAN I/F 183 conforming to IEEE802.11 or the like.

A disk recording/reproducing device 14 is connected to the router 18, and hence an in-home network may be constituted. The disk recording/reproducing device 14 incorporates therein a hard disk drive, is configured to dub a program recorded on the hard disk drive onto a disk medium, and serves as a recording device configured to complement the hard disk drive of the television receiver 12. Although not shown, an external hard disk drive of the television receiver 12 can also be connected to the router 18.

A satellite digital broadcast signal received by an antenna 102 for receiving the BS/110° CS digital broadcast is supplied to a tuner 108 for the satellite digital broadcast through an input terminal 106, whereby a broadcast signal of a desired channel is selected. Although only one unit of the tuner 108 is shown in FIG. 1, actually two units of BS/110° CS digital tuners are provided.

A terrestrial digital television broadcast signal received by an antenna for receiving the terrestrial broadcast is supplied to tuners 112A, 112B, and 112C through an input terminal 110, whereby a broadcast signal of a desired channel is selected. Although only three units of tuners 112 are shown in FIG. 1, more units of terrestrial digital tuners may be provided.

Broadcast signals in paid broadcasting are scrambled. Further, broadcasting is not limited to that associated with receiving a radio wave propagated through the air, and may also include that in which a program distributed from a broadcast station through a network such as cable, IP (Internet protocol), and the like can be received.

The signal of a broadcast program received by the tuners 108, 112A, 112B, and 112C is input to a TS processor 122 functioning as a re-multiplexing section, and transport streams (TSs) of a plurality of channels (CHs) are re-multiplexed into one TS.

Packets of TSs of a plurality of channels are time-division multiplexed into the TS output from the TS processor 122. Accordingly, in, for example, a case of input of 4 channels, the TS processor 122 subjects an arrangement of packets to time-division multiplexing at a rate five times as large as the input to output a multiplexed TS. Further, a control information packet is embedded in the packet arrangement of the multiplexed TS. The control information packet carries control information such as time stamp information, packet arrangement sequence information, and the like of the channel packet for each multiplexed channel.

The TS re-multiplexing system is not limited to the system described here, and various methods can be used. The TS re-multiplexed by the TS processor 122 is sent to a TS separator 123. The TS separator 123 separates an entitlement control message (ECM) which is encryption information, and an event information table (EIT) which is a table describing event information such as a program name, cast, start time, and the like from the signal of the broadcast program. Further, electric program guide (EPG) data or the like is also separated from the signal, and is supplied to a control module 150. The TS of the broadcast program is sent to a program TS processor 124.

In the television receiver 12, all the operations including the above-mentioned various receiving operations are controlled by the control module 150 in a unified manner. The control module 150 incorporates therein a central processing unit (CPU) 154, receives operation information from an operation module 152 arranged at the front of the cabinet, or receives operation information transmitted from a remote controller 170 and received by a remote control receiver 172, and controls each section in such a manner that the control contents are reflected.

Furthermore, the control module 150 receives operation information from a portable terminal (not shown) to be supplied through a communication I/F 182, and can control each section in such a manner that the operation contents are reflected, and can also supply various status signals of the television receiver 12 to the portable terminal through the communication I/F 182, LAN terminal 180, and router 18.

The control module 150 mainly includes a read only memory (ROM) 156 storing therein a control program to be executed by the CPU 154 thereof, random access memory (RAM) 158 configured to provide a work area for the CPU 154, nonvolatile memory 160 in which various setting information, control information, EPG data, and the like are stored, reservation setting module 162, program guide creation module 164, recording/reproduction module 166, and image quality adjustment module 168. The program guide creation module 164 creates an electronic program guide on the basis of EPG data acquired in advance through a broadcast signal or a network or the like, and image-displays the created program guide on a screen. The EPG data is normally acquired through a broadcast signal, and the EPG data is separated from a broadcast signal received through the antenna by controlling the tuners 108, 112A, 112B, and 112C. However, in addition to the above, it is also possible to acquire the EPG data from the network through the communication I/F 182, and LAN terminal 180. The EPG data is stored in the nonvolatile memory 160. Thereby, it is possible for the user to select a desired program from the image-displayed electronic program guide, and carry out viewing, recording reservation or the like. The reservation setting module 162 carries out reservation of recording/viewing of a broadcast program. The recording/reproduction module 166 executes recording on the basis of reservation information of the reservation setting module 162 to thereby carry out reservation recording of a program.

The control module 150 is connected, through a card I/F 178, to a card holder 176 to which a memory card (IC card) 174 can be attached. Thereby, the control module 150 can carry out information transmission between itself and the memory card 174 attached to the card holder 176 through the card I/F 178. The memory card 174 is configured to record thereon, for example, contract information or the like of a broadcast reception contract.

The control module 150 can carry out information transmission between itself and the disk recording/reproducing device 14, personal computer, and the like connected to the router 18. Further, the control module 150 is also connected to the Internet through the router 18.

The control module 150 is connected to a USB terminal 186 through a USB I/F 188. Thereby, the control module 150 can carry out information transmission, through the USB I/F 188, between itself and a USB-compliant hard disk drive (HDD) 184 connected to the USB terminal 186. It should be noted that the hard disk drive is not limited to an external one, and may be one incorporated in the receiver 12. An internal hard disk drive is connected to the control module 150 through an ATA interface (not shown) or the like. Further, in the case of the external hard disk drive, the number of hard disk drives is not limited to one, and a plurality of hard disk drives can be connected. Furthermore, the hard disk drive may be a LAN-connected one.

In the program TS processor 124, regarding a program stream associated with a paid program, descrambling or the like is carried out. A key for descrambling is created by the control module 150. The control module 150 creates the key by utilizing information included in the ECM, contract information of the memory card 174, and the like. A program stream associated with a free program is passed without being descrambled.

The program TS output from the program TS processor 124 is supplied to a selector 125, and recording/reproduction module 166 in the control module 150. The selector 125 selects a TS of a program which the user desires to watch, and supplies the selected TS to an AV decoder 126. Video data included in a video packet in the program TS is encoded by, for example, the moving picture expert group (MPEG) system, advanced video coding (AVC) system, and the like. Further, audio data in the audio packet is encoded by, for example, the pulse code modulation (PCM) system, Dolby system, MPEG system, and the like. The AV decoder 126 separates a video packet and audio packet from each other, and decodes data in each packet according to each system.

The decoded audio data is subjected to sound-volume/sound-quality adjustment in a audio processor 130 to be converted into an analog audio signal, and is thereafter supplied to a speaker system 132.

The decoded video data is supplied to a graphics processor 134. The graphics processor 134 has a function of superimposing an OSD signal created in an on-screen display (OSD) signal creating section 136 on a digital video signal supplied from the AV decoder 126, and outputting the resultant signal. Further, the graphics processor 134 can selectively output an output video signal of the AV decoder 126, and output OSD signal of the OSD signal creating section 136, and can combine both the output signals with each other in such a manner that each of the output signals constitutes half the screen, and output the combined signal.

The digital image signal output from the graphics processor 134 is supplied to a video processor 138. The video processor 138 converts the input digital video signal into an analog video signal of a format which can be displayed on a display 140 constituted of an LCD panel, plasma display panel, SED panel or the like, and thereafter outputs the analog video signal to the display 140 to cause the display 140 to display the image. The video processor 138 also adjusts the image quality, color, display scale, line number, resolution, and the like. Adjustment/control data items for the audio processor 130, and video processor 138 are supplied from the control module 150.

The recording/reproduction module 166 can supply the program TS output from the program TS processor 124 to the hard disk drive 184 through the USB terminal 186, and/or can supply the program TS to the disk recording/reproducing device 14 through the communication I/F 182, LAN terminal 180, and router 18. The hard disk drive 184 is a high-capacity recording device capable of recording received broadcast programs of a plurality of channels for a predetermined time (for example, 6 channels for 40 hours). The disk recording/reproducing device 14 can carry out reproduction of a removable disk such as a DVD, BD, and the like or can carry out signal recording on these disks. The disk recording/reproducing device 14 is connected to the television receiver 12 through an in-home network, and hence can function as an in-home server.

The control module 150 includes the program guide creation module 164. The program guide creation module 164 can manage a program guide already stored in the hard disk drive 184, and associated with a program broadcast in the past, program guide associated with a program presently being broadcast, and program guide associated with a program to be broadcast in the future (within about one month) in a state where the program guides are connected in series by utilizing EPG data associated with programs of the past, present, and future.

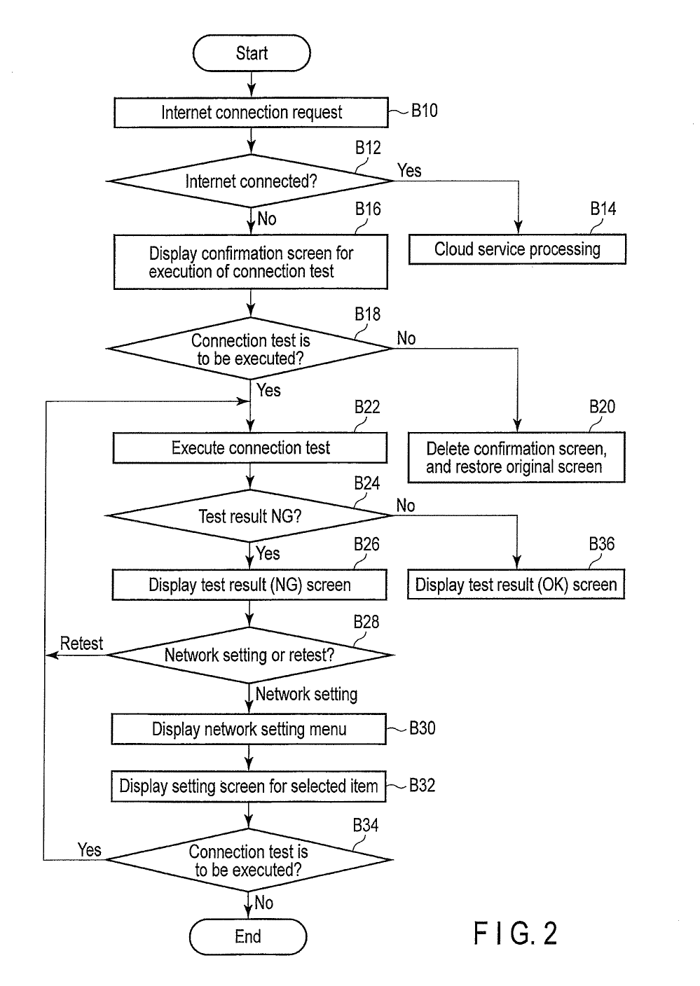

FIG. 2 is a flowchart of an Internet connection test method. When a function such as a cloud service or the like requiring Internet connection is selected in block B10, the processing of FIG. 2 is started.

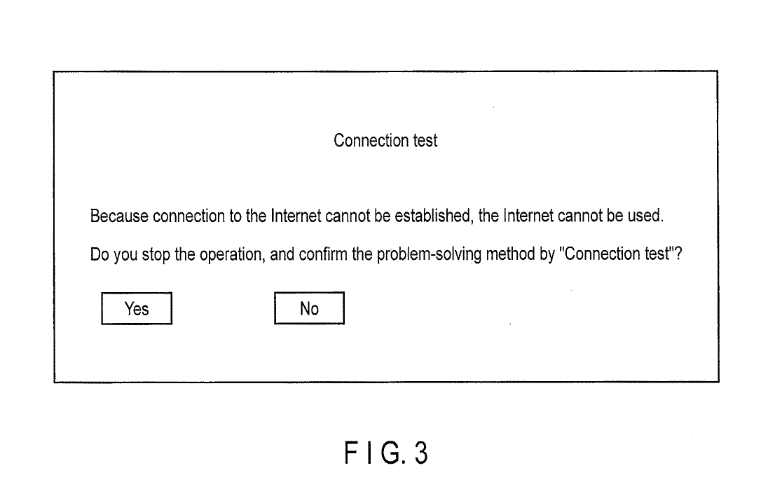

In block B12, it is determined whether or not Internet connection has been established. When Internet connection has been established, the flow is advanced to the processing (block B14) of the cloud service. When Internet connection has not been established yet, a confirmation screen including a message stating that a cloud service is not available because of a failure in the connection to the Internet, and message confirming whether or not a connection test is to be executed in order to determine the cause of the unsuccessful connection is displayed in block B16. An example of a confirmation screen is shown in FIG. 3. The confirmation message asks the user whether or not a connection test is to be executed. This is done in order to confirm whether or not the connection test can be executed at this point of time because the connection test takes several minutes. There is the possibility of the user selecting the cloud service without recognizing the necessity of Internet connection, and hence a choice of restoring the original state without executing the connection test is also prepared.

It is determined in block B18 whether or not execution of the connection test is to be instructed. When execution of the connection test is not instructed (“No” in FIG. 3 is selected), the confirmation screen is deleted in block B20, and the original screen (screen before the processing of FIG. 2 is started) is restored.

When execution of the connection test is instructed (“Yes” in FIG. 3 is selected), the connection test is executed in block B22. During execution of the connection test, a message indicating “Test being executed” is displayed on the screen.

The connection test includes a test between the television receiver 12 and router 18 (access point), and test between the router 18 and Internet 24. The test between the television receiver 12 and router 18 includes five items of, for example, (1) connection type (wireless or wired), (2) MAC address, (3) connection state, (4) IP address, and (5) DNS setting. The test between the router 18 and Internet 24 includes two items of, for example, (6) proxy setting, and (7) Internet connection.

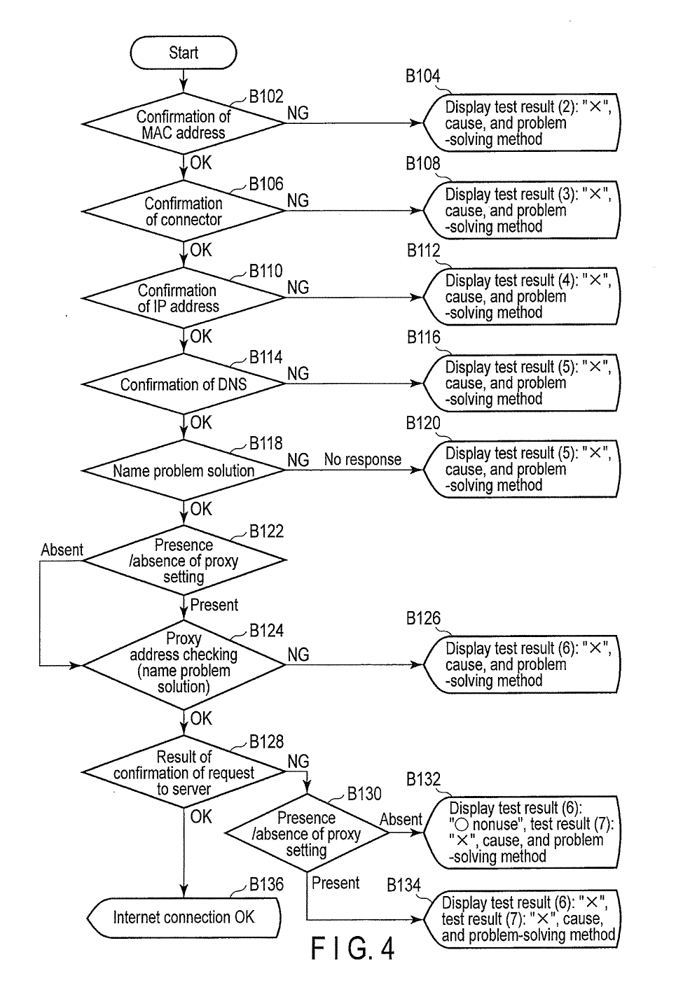

An example of details of the connection test of the case where the connection type between the television receiver 12 and router 18 is wired is shown in FIG. 4.

In block B102, the MAC address is confirmed. When the confirmation result of the MAC address is NG, “x” is displayed in the test result of (2) MAC address in block B104, and a cause, and problem-solving method corresponding to the result are displayed. As an example, “The MAC address is not normally read” is displayed as the cause, and “Take a note of the displayed message, and make inquiries at our company's service center” is displayed as the problem-solving method.

When the confirmation result of the MAC address is OK, the connector is confirmed in block B106. When the connection of the connector is NG, “x” is displayed in the test result of (3) connection state in block B108, and a cause, and problem-solving method corresponding to the result are displayed. As an example, “The LAN cable is not correctly connected between the TV receiver and connection device” is displayed as the cause, and “Confirm whether or not the LAN cable has come off between the TV receiver and connection device/Replace the LAN cable with another one/Confirm whether or not the power of the connection device is on. When setting is carried out from the beginning, select “Network setting”, and operate from “Simple network setting”” is displayed as the problem solving method. The connection device includes a router, hub, and the like.

When the connection of the connector is OK, the IP address is confirmed in block B110. When the confirmation of the IP address is NG, “x” is displayed in the test result of (4) IP address in block B112, and a cause, and problem-solving method corresponding to the result are displayed. As an example, “The IP address is being acquired now/Connection to the router is not correct/The IP address is not correctly set” is displayed as the cause, and “Select “Retest” after waiting a while. When this error occurs even after waiting a while, confirm whether or not the DHCP function of the router is effectively set. For further information, confirm the instruction manual of the router/Confirm whether or not the power of the router is switched on. Confirm whether or not the LAN cable has come off between the switching hub and router. Confirm whether or not the DHCP function of the router is effectively set. For further information, confirm the instruction manual of the router/select “Network setting”, and correctly set, from “IP address setting”, IP address, Subnet mask, and Default gateway” is displayed as the problem-solving method.

When the confirmation of the IP address is OK, the DNS is confirmed in block B114. When the DNS is NG, “x” is displayed in the test result of (5) DNS setting in block B116, and a cause, and problem-solving method corresponding to the result are displayed. As an example, “The DNS address is not correctly set” is displayed as the cause, and “The DNS addresses of the TV and router do not coincide with each other. Confirm the DNS setting of this device. Select “Network setting”, and set the DNS address from “DNS setting”. For further information, confirm the instruction manual of the router” is displayed as the problem-solving method.

When the confirmation of the DNS is OK, it is confirmed in block B118 whether or not a problem with the name has been solved. When the name cannot be confirmed (no response), “x” is displayed in the test result of (5) DNS setting in block B120, and a cause, and problem-solving method corresponding to the result are displayed. As an example, “There is no response from the router/The router does not normally operate” is displayed as the cause, and “Confirm the DNS setting of this device or the setting of the router. Select “Network setting”, and confirm the DNS address from “DNS setting”. Confirm whether or not the power of the router is on. Insert the LAN cable into the router (WAN side). Confirm whether or not the account information specified by the provider is correctly set to the router (WAN side). For further information, confirm the account information delivered at the time of contracting with the provider, and instruction manual of the router/Confirm the router (WAN side). Insert the LAN cable into the router (WAN side). Confirm whether or not the account information specified by the provider is correctly set to the router (WAN side). For further information, confirm the account information delivered at the time of contracting with the provider, and instruction manual of the router” is displayed as the problem-solving method.

When the name can be confirmed, presence/absence of the proxy setting is determined in block B122. When the proxy setting is present, the proxy address is checked (whether or not the name problem has been solved) in block B124. When the proxy address is NG, “x” is displayed in the test result of (6) proxy setting in block B126, and a cause, and problem-solving method corresponding to the result are displayed. As an example, “The proxy address cannot be acquired” is displayed as the cause, and “Confirm the setting of this device or the router. Select “Network setting”, and confirm the input contents of the “Proxy setting”. For further information, inquire of the network administrator” is displayed as the problem-solving method.

When the checking of the proxy address is OK, a result of confirmation of a request to the server is examined in block B128. When the confirmation result is OK, the test result (OK) is displayed in block B136. When the confirmation result is NG, presence/absence of the proxy setting is determined in block B130. When the proxy setting is absent, “o nonuse” is displayed in the test result of (6) proxy setting in block B132, “x” is displayed in the test result of (7) Internet connection, and a problem-solving method corresponding to the result is displayed without displaying the cause. As an example, “Confirm the router (WAN side). Insert the LAN cable into the router (WAN side). Confirm whether or not the account information specified by the provider is correctly set to the router (WAN side). For further information, confirm the account information delivered at the time of contracting with the provider, and instruction manual of the router. If you cannot use the Internet even after the confirmation, consult the provider” is displayed as the problem-solving method. When the proxy setting is present, “x” is displayed in the test result of (6) proxy setting in block B134, “x” is displayed in the test result of (7) Internet connection, and a problem-solving method corresponding to the result is displayed without displaying the cause. As an example, “Confirm the proxy setting of this device. Select “Network setting”, and confirm the input contents of “Proxy setting”. Insert the LAN cable into the router (WAN side). Confirm whether or not the account information specified by the provider is correctly set to the router (WAN side). For further information, confirm the account information delivered at the time of contracting with the provider, and instruction manual of the router. If you cannot use the Internet even after the confirmation, consult the provider” is displayed as the problem-solving method.

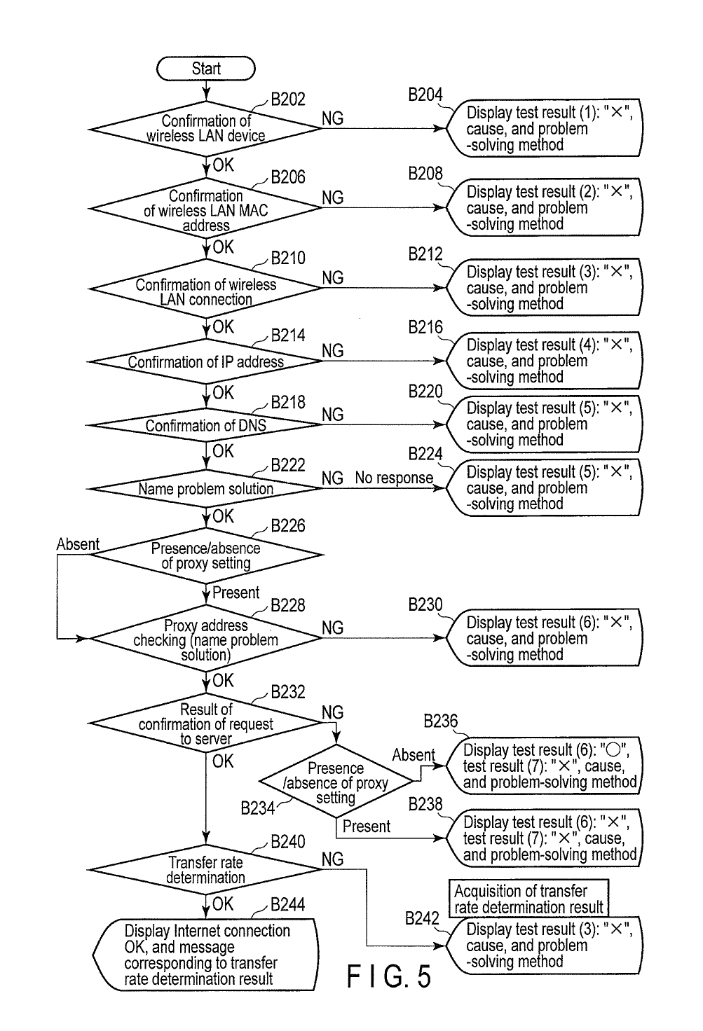

An example of details of the connection test of the case where the connection type between the television receiver 12 and router 18 is wireless is shown in FIG. 5.

In block B202, the connection state of the wireless LAN I/F 183 is confirmed. When the connection is NG, “x” is displayed in the test result of (1) connection type in block B204, and a cause, and problem-solving method corresponding to the result are displayed.

When the connection is OK, the MAC address of the wireless LAN is confirmed in block B206. When the confirmation of the MAC address is NG, “x” is displayed in the test result of (2) MAC address in block B208, and a cause, and problem-solving method corresponding to the result are displayed.

When the MAC address is OK, the state of the wireless LAN connection is confirmed in block B210. When the connection state is NG, “x” is displayed in the test result of (3) connection state in block B212, and a cause, and problem-solving method corresponding to the result are displayed.

When the connection state is OK, the IP address is confirmed in block B214. When the confirmation of the IP address is NG, “x” is displayed in the test result of (4) IP address in block B216, and a cause, and problem-solving method corresponding to the result are displayed.

When the confirmation of the IP address is OK, the DNS is confirmed in block B218. When the DNS is NG, “x” is displayed in the test result of (5) DNS setting in block B220, and a cause, and problem-solving method corresponding to the result are displayed.

When the confirmation of the DNS is OK, it is confirmed in block B222 whether or not a problem with the name has been solved. When the name cannot be confirmed (no response), “x” is displayed in the test result of (5) DNS setting in block B224, and a cause, and problem-solving method corresponding to the result are displayed.

When the name can be confirmed, presence/absence of the proxy setting is determined in block B226. When the proxy setting is present, the proxy address is checked (whether or not the name problem has been solved) in block B228. When the proxy address is NG, “x” is displayed in the test result of (6) proxy setting in block B230, and a cause, and problem-solving method corresponding to the result are displayed.

When the checking of the proxy address is OK, a result of confirmation of a request to the server is examined in block B232. When the confirmation result of the request is NG, presence/absence of the proxy setting is determined in block B234. When the proxy setting is absent, “o” is displayed in the test result of (6) proxy setting in block B236, “x” is displayed in the test result of (7) Internet connection, and a problem-solving method corresponding to the test result is displayed without displaying the cause. When the proxy setting is present, “x” is displayed in the test result of (6) proxy setting in block B238, “x” is displayed in the test result of (7) Internet connection, and a problem-solving method corresponding to the test result is displayed without displaying the cause.

When the confirmation result of the request to the server is OK in block B232, the transfer rate is determined in block B240. When the determination result of the transfer rate is NG, “x” is displayed in the test result of (3) connection state in block B242, and a problem-solving method corresponding to the test result is displayed without displaying the cause.

When the determination result of the transfer rate is OK, a test result (OK) is displayed in block B244. It should be noted that a message corresponding to the transfer rate is additionally displayed. An example of the message of the case where the transfer rate is rate 1 (lowest) is “Connection to the Internet has been established. The rate of the wireless LAN is not sufficient. There is the possibility of the image/sound being stopped or making a strange sound when the image content items are delivered or viewed”. When the transfer rate is rate 2, “Connection to the Internet has been established. The rate of the wireless LAN is not sufficient. There is the possibility of the function of utilizing the network being unable to normally operate. Confirm the setting of the access point” is displayed. When the transfer rate is rate 3, “Connection to the Internet has been established. The rate of the wireless LAN is not sufficient. Although Internet browsing or normal reproduction of the image content items can be carried out, when quick-viewing reproduction is carried out, there is the possibility of the image/sound being stopped or making a strange sound.” is displayed. When the transfer rate is rate 4, “Connection to the Internet has been established. The rate of the wireless LAN is not sufficient. Although delivery and viewing of the image content items can be carried out, when these operations are simultaneously carried out, there is the possibility of the image/sound being stopped or making a strange sound.” is displayed. When the transfer rate is rate 5 (highest), “Connection to the Internet has been established. The transfer rate of the wireless LAN sufficient for utilizing all the communication functions of this device has been confirmed.” is displayed.

In block B22 of FIG. 2, the test items are sequentially tested as described above. It is determined in block B24 whether or not the test result is NG, and, even when there is only one NG test item, the connection test is suspended at that point of time, and the test result (NG) screen is displayed in block B26. When it is determined that the test result is NG in each of blocks B102, B106, B110, B114, B118, B124, and B130 of FIG. 4, or when it is determined that the test result is NG in each of blocks B202, B206, B210, B214, B218, B222, B228, B234, and B240 of FIG. 5, block B26 is executed.

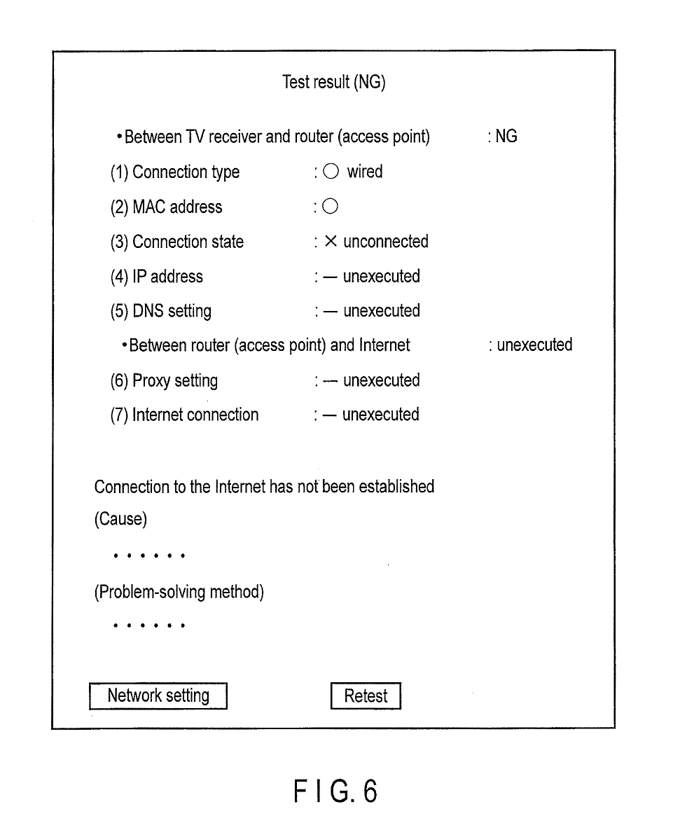

An example of a test result (NG) screen is shown in FIG. 6. A test result for each item is shown by “o” or “x”. Test items subsequent to the first test item marked with “x” show that they are not executed yet. Subsequently to a note indicating that connection to the Internet has failed, a cause of the failure and problem-solving method are displayed. Finally, a “Network setting” button, and “Retest” button necessary for execution of the problem-solving method are displayed. FIG. 6 shows a test result screen of a case where the connection type is wired, connection state of the connector for connection to the router 18 is abnormal, and determination of block B106 of FIG. 4 is NG. As an example of the cause, “Confirm whether or not the LAN cable has come off between the TV receiver and connection device” is displayed. As an example of the problem-solving method, “Confirm whether or not the LAN cable has come off between the TV receiver and connection device”. Alternatively, Replace the LAN cable with another one/Confirm whether or not power of the connection device is on. When setting is carried out from the beginning, select “Network setting”, and operate from “Simple network setting” is displayed.

In block B28, it is determined which of “Network setting” and “Retest” has been selected. When “Retest” is selected, the flow is returned to block B22, and the connection test is carried out again.

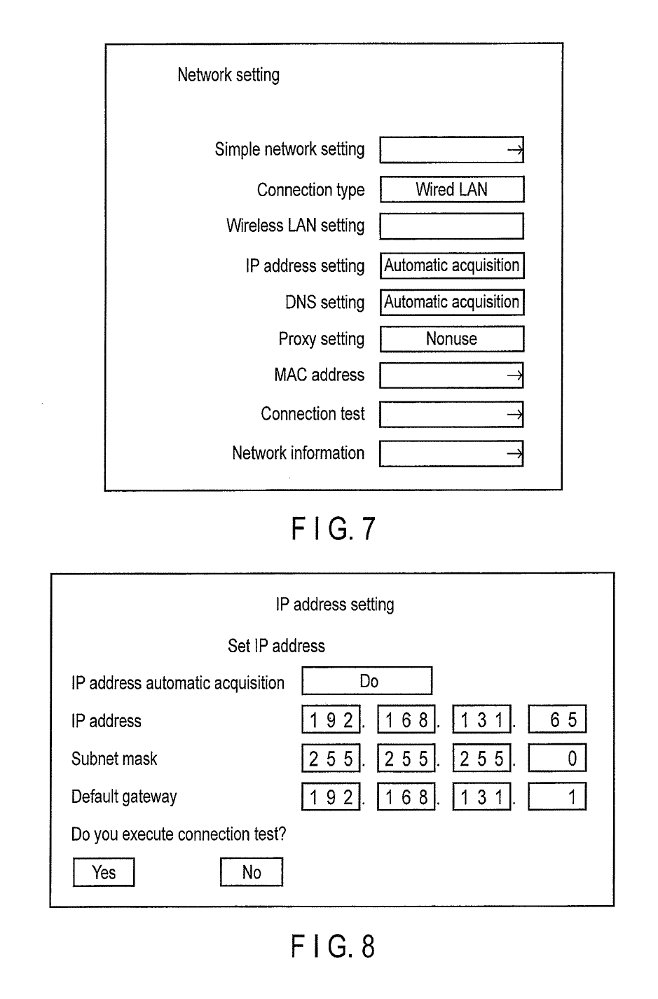

When “Network setting” is selected, a network setting menu shown in FIG. 7 is displayed in block B30. The network setting menu includes a plurality of setting items, and, when any one of the setting items is selected, a procedure for setting the selected item is displayed. A focus position is set to one of the plurality of setting items according to the test result. When one of the three test items of (1) connection type, (2) MAC address, and (3) connection state is NG, the focus position is set to simple network setting. When the test item of (4) IP address is NG, the focus position is set to IP address setting (au acquisition). When the test item of (5) DNS setting is NG, the focus position is set to DNS setting (automatic acquisition). When the test item of (6) proxy setting is NG, the focus position is set to proxy setting (nonuse). When the test item of (7) Internet connection is NG, the focus position is set to network information. As described above, a menu in which the focus position is set to a setting item corresponding to the cause of the failure in the connection to the Internet is displayed, and hence it is possible for the user to easily select an item to be set, and easily carry out Internet setting.

When a setting item of the network setting menu to which the focus position is set, e.g., the item of IP address setting (automatic acquisition) is selected, an IP address acquisition screen shown in FIG. 8 is displayed in block B32. It should be noted that although the other setting item of the network setting menu can be selected, the focus position is set to a setting item corresponding to the cause of the failure in the connection to the Internet, and hence, normally a setting item of the focus position is selected. Accordingly, when “Network setting” is selected in the displayed test result (NG) screen of block B26, the IP address acquisition screen of FIG. 8 may be immediately displayed without displaying the network setting menu of FIG. 7. That is, block B30 may be skipped, and subsequently to block B28, block B32 of displaying a setting screen of an item which has become NG in the connection test may immediately be executed.

When the acquisition of the IP address is completed, a button used to select whether or not the connection test is to be executed is displayed in block B34.

When execution of the connection test is selected, the flow is returned to block B22, and the connection test is executed. When execution of the connection test is not selected, the processing is terminated.

In the above description, in the test of FIG. 4 or FIG. 5, when determination about any one of the items becomes NG, the tests of the subsequent items are not executed, and hence when setting (acquisition) of the IP address which is one of the setting items is completed, the connection test is executed. However, in the test of FIG. 4 or FIG. 5, even when determination about any one of the items becomes NG, if the tests of all the items are executed, a choice of returning the flow to the network setting menu in order to select some other setting item (when there is the possibility of some other setting item being left undone) without immediately executing the connection test even when setting (acquisition) of the IP address which is one of the setting items is completed may also be prepared.

Further, in a network setting screen shown in FIG. 7, a button for selecting whether or not the connection test is to be executed may not necessarily be displayed. When any one of the test items of (1) connection type, (2) MAC address, and (3) connection state is NG, the button for selecting whether or not the connection test is to be executed is not displayed. That is, when the focus position is set to simple network setting, and simple network setting is selected in FIG. 7, after setting of (1) connection type, (2) MAC address or (3) connection state, the connection test is executed without fail.

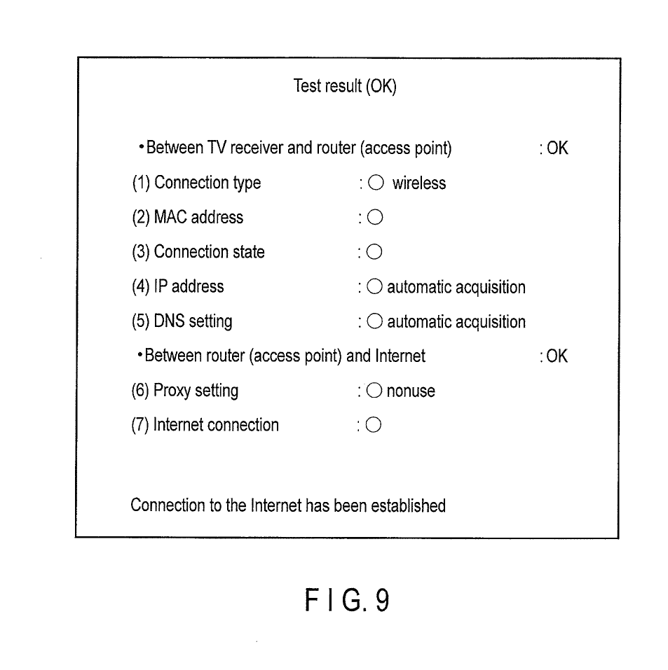

When all the test results become OK by the determination of the test result of block B24, a test result (OK) message is displayed in block B36. An example of a test result (OK) message is shown in FIG. 9. It should be noted that when the connection type is wireless, even when the test result is OK, a note message corresponding to the transfer rate is displayed as described in block B244 of FIG. 5.

As has been described above, according to the first embodiment, with respect to a function requiring Internet connection, it is possible to urge the user to carry out the connection test when Internet connection cannot be established, and display a cause of being unable to establish connection, and problem-solving method to thereby guide the user to a setting screen of items necessary for solving the problem. Accordingly, it is possible even for a user unfamiliar with Internet connection to easily set items necessary for Internet connection, and establish Internet connection.

Although the embodiment has been described by taking a television receiver as an example, the present invention is applicable to all kinds of electronic devices to be connected to the Internet.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

It should be noted that the present invention is not limited to the above-mentioned embodiment as it is, and, in the implementation stage, the constituent elements can be modified and embodied within a range not deviating from the gist of the invention. Further, by appropriately combining a plurality of constituent elements disclosed in the above embodiment with each other, various inventions can be formed. For example, some of the constituent elements may be deleted from all the constituent elements shown in the embodiment. Furthermore, constituent elements ranging over different embodiments may be appropriately combined with each other.

What is claimed is:

1. An electronic device comprising:
a test module configured to test setting states of items necessary for Internet connection;
a specification module configured to specify a cause of being unable to establish connection to the Internet based on an item regarding which it has been determined by the test means that setting is not correctly carried out; and
a first display configured to display the cause specified by the specification module.

2. The electronic device of claim 1, wherein
the first display is configured to display an item associated with the cause, and to urge a user to carry out setting of the displayed item.

3. The electronic device of claim 2, wherein
the first display is configured to display a setting procedure of the item associated with the cause.

4. The electronic device of claim 2, wherein
the first display is configured to display a menu comprising the items necessary for Internet connection, and a focus position is set to the item associated with the cause.

5. The electronic device of claim 4, further comprising a second display configured to display, when an item is selected in the menu, a setting procedure of the selected item.

6. The electronic device of claim 3, further comprising a module configured to cause, when setting is carried out after the setting procedure is displayed, the test module, the specification module, and the first display means to automatically execute a test.

7. The electronic device of claim 3, wherein
when setting is carried out after the setting procedure is displayed, the test module, the specification module, and the first display module are caused to execute a test based on an instruction of the user.

8. A connection test method comprising:
testing setting states of items necessary for Internet connection;
specifying a cause of being unable to establish connection to the Internet; and
displaying the specified cause.

9. The connection test method of claim 8, further comprising displaying an item associated with the cause, and urging a user to carry out setting of the displayed item.

10. The connection test method of claim 9, wherein
urging the user comprises displaying a setting procedure of the item associated with the cause.

11. The connection test method of claim 9, wherein
urging the user comprises displaying a menu comprising the items necessary for Internet connection, and a focus position being set to the item associated with the cause.

12. The connection test method of claim 11, further comprising displaying, when an item is selected in the menu, a setting procedure of the selected item.

13. The connection test method of claim 10, further comprising automatically executing, when setting is carried out after the setting procedure is displayed, testing setting states, specifying the cause, and displaying the specified cause.

14. The connection test method of claim 10, further comprising executing, when setting is carried out after the setting procedure is displayed, testing setting states, specifying the cause, and displaying the specified cause based on an instruction of the user.

15. A connection test method comprising:
testing, when Internet connection cannot be established at the time of receipt of a request for Internet connection, items necessary for Internet connection; and
specifying a cause of being unable to establish connection to the Internet.

16. The connection test method of claim 15, wherein
testing comprises determining whether or not Internet connection may be carried out; and automatically starting a test when a determination result is “No”.

17. The connection test method of claim 15, wherein
testing comprises determining whether or not Internet connection may be carried out; displaying a message asking the user whether or not a test may be executed when a determination result is “No”; and starting a test based on an instruction of the user.
